(19) United States
(12) Patent Application Publication
(10) Pub. No.: US 2009/0034800 A1
(43) Pub. Date: Feb. 5, 2009

(54) Method Of Automatic Navigation Directed Towards Regions Of Interest Of An Image

(75) Inventors: Jean-Marie Vau, Paris (FR); Christophe E. Papin, Bois Colombes (FR); Kazuki N. Chhoa, Breuillet (FR); Olivier A. Furon, Dinard (FR)

Correspondence Address: EASTMAN KODAK COMPANY;PATENT LEGAL STAFF, 343 STATE STREET, ROCHESTER, NY, 14650-2201, US

(73) Assignee: Eastman Kodak Company, Rochester, NY (US)

(21) Appl. No.: 11/719,986

(22) PCT Filed: Nov. 7, 2005
(86) PCT No.: PCT/EP2005/011869

§ 371 Date: May 23, 2007

(30) Foreign Application Priority Data
Nov. 26, 2004 (FR) 0142647

(51) Int. Cl. G06K 9/00; H04M 1/00

(52) U.S. Cl. 382/107; 455/566

(57) ABSTRACT

The invention is in the technological field of digital imaging. More specifically, the invention relates to a method of automatic navigation between a digital image (8) and a region of interest (14, 15) of this image (8). The method according to the invention enables, based on the display of the initial image (8) on a display screen (2) of a mobile terminal (1) comprising a movement detection means (4), automatic navigation towards a region of interest (14) or (15) of the initial image (8), without manual control, and simply by transmitting, for example, a tilting movement to the terminal (1) in the direction of the region of interest (14, 15). The method according to the invention is used with portable or mobile terminals, for example cellphones or phonecams.

### FIELD OF THE INVENTION

The invention is in the technological field of digital imaging. More specifically the invention relates to a method of automatic navigation, based on a mobile or portable terminal provided with a display screen, between a digital image and one or more regions of interest of this image, by proceeding directly to the physical displacement of the mobile terminal. The term “navigation” means going from the display of an initial digital image to the display of a region of interest of this initial image.

### BACKGROUND OF THE INVENTION

Digital images captured by video or digital cameras are then frequently viewed on the display screens of portable terminals. Portable or mobile terminals are increasingly widespread phone and visual communication means. Mobile terminals, e.g. digital cameras; cellphones, equipped or not with capturing means; personal assistants or PDAs (Personal Digital Assistant); or again portable multimedia readers-viewers (e.g. iPod photo) have geometrical shapes that are easy to manipulate, and can be held in a user's hand. When an image is displayed on the screen, for example of a cellphone, the size of the screen is not necessarily sufficient to display all the pixels of an image in good conditions. Further, a terminal user may feel the need to be able to move towards a particular area of the image, because they see an interest there. To see the particular zone of interest better, commonly called the “region of interest”, the user can perform a selection operation of the region of interest in the displayed initial image. The region of interest can be selected automatically just before the navigation, at the same time as the navigation, or even previously and independently of it. This selection enables the region of interest to be displayed full screen, to obtain an enlargement of the zone selected in the initial image.

International Patent Application WO 2004/066615 discloses mobile or portable terminals, having small screens, for example a mobile cellphone. The mobile cellphone has the means to detect a movement imparted to the phone, for example an optical sensor or an accelerometer. This enables navigation based on an initial image, e.g. moving in the plane of an image displayed with a resolution higher than the screen's, or again turning a displayed initial image, by translation or rotation respectively of the phone in space, or zooming in on this initial image, by moving the phone in a direction perpendicular to the plane of the phone's screen. This enables use of the manual control keys of the phone's keyboard to be limited, while advantageously navigating in an image to be able to display various image areas, and make enlargements as required. However, International Patent Application WO 2004/066615 does not disclose any means for optimizing the navigation towards a region of interest, and reducing the number of clicks required using the control keys of the portable terminal, for navigating completely automatically (without clicks, or no clicks), based on a displayed initial image, in order to display a region of interest of the initial image.

### SUMMARY OF THE INVENTION

It is an object of the invention, based on an initial image displayed on the screen of a mobile terminal, to navigate in a robust, user friendly way and without clicks, towards zones or regions of interest selected in the initial image. For example, no clicks or interaction with a keyboard or a light pen are necessary to zoom from an initial image displayed full screen towards a region of interest belonging to this initial image. You just impart or transmit a particular movement to the portable terminal, so that the initial image is transformed gradually and automatically into another image which represents a region of interest of the initial image. Advantageously the region of interest is automatically shown full screen on the mobile terminal. The region of interest is not necessarily selected, as such, by the user of the mobile terminal. In this case, the region of interest is extracted prior to the operation of navigating, based on metadata encoded along with the image, and integrated for example into the header, or an attached file.

It is also an object of the invention to assist and facilitate the calculation of the displacements imparted by movements of the mobile terminal, and to optimize the convergence, i.e. zooming, towards one or more regions of interest. In particular, the knowledge of one or more regions of interest, towards which the user wishes to navigate, advantageously directs the search space used during the estimation of the terminals movement, especially if the data used comes from an optical sensor. Prior knowledge of the “3D” (three dimensional) path to follow, to converge onto a region of interest, enables optimization of the characteristics of the intermediate images to be displayed, as well as those of the transformation parameters to be applied.

It is an object of the invention to facilitate and optimize intra-image navigation, based on a mobile terminal provided with a display screen. More specifically, the object of the invention is a method of navigating automatically towards a region of interest of an initial image, using a device comprising a mobile terminal, a movement detection means, and a display means; the method comprising the following steps:
a) displaying the initial image on the display means;
b) automatically determining at least one pixel zone of the initial image, the pixel zone representing a region of interest of the initial image;
c) automatically measuring, using the movement detection means, spatiotemporal changes imparted by a displacement of the mobile terminal;
d) automatically linking the data of pixels specific to the regions of interest detected in b) and the spatiotemporal changes measured in c) to automatically estimate movement information;
e) automatically navigating, based on the movement information and using the data of pixels specific to the regions of interest of the initial image, towards the defined region of interest, with a sequential display of intermediate images;
f) automatically displaying the image of the region of interest full screen on the display means.

The method according to the invention thus enables automatic display of the image of the region of interest on the display means of the mobile terminal.

It is an object of the invention to automatically determine a region of interest that was identified prior to displaying the initial image, and that was stored or memorized in a formatted way in the header of the initial image, or that was memorized independently as a file that can be interpreted by the detection means of spatiotemporal changes.

The invention also enables determination of the region of interest to be activated prior to and as a result of an image navigation request.

The determination of the region of interest can also, according to the invention, be refined during the navigation step.

It is also an object of the invention that the determination of the region of interest is directed to a zone determined by the direction obtained by the detection means of spatiotemporal changes.

It is also an object of the invention to provide a method in which the initial image has many regions of interest that can be shown successively on the display means.

Other characteristics and advantages will appear on reading the following description, with reference to the drawings of the various figures.

### BRIEF DESCRIPTION OF THE DRAWINGS

FIG. 1 shows an example of the mobile terminal used to implement the method according to the invention.

FIG. 2 represents an initial image intended to be transformed according to the invention method.

FIG. 3 represents an image automatically transformed based on the display of the initial image.

### DETAILED DESCRIPTION OF THE INVENTION

The following description describes the main embodiments of the invention, with reference to the drawings, in which the same numerical references identify the same elements in each of the different figures.

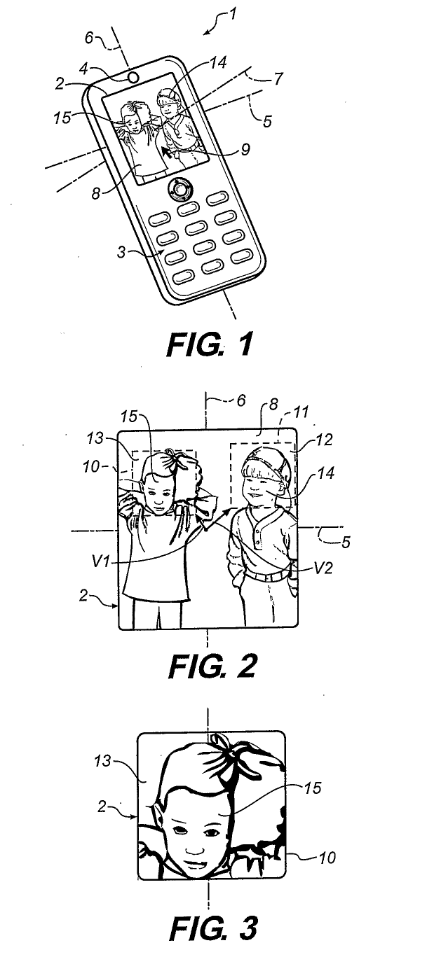

FIG. 1 represents a mobile terminal 1, for example a cellphone. The mobile terminal 1 can also be a digital camera, a digital camscope, a phonecam, a digital reader-viewer, a digital PDA (Personal Digital Assistant), or a PC tablet. The cellphone 1 advantageously includes a display screen 2 and a keyboard 3. The mobile terminal also comprises movement detection means 4. In an advantageous embodiment, the movement detection means 4 uses the data coming from one or more optical sensors. Advantageously, the optical sensor is placed on the rear surface opposite the screen 2.

In a preferred embodiment, the navigation method in particular comprises four separate steps, which are applied successively or simultaneously, and which operate in a closed navigation loop. This means that the last step of the four steps of the navigation method activates the first of these steps again, and this continues until the user wishes to stop the navigation method in a given image. The implementation or simultaneous or successive activation of these four steps is called iteration, and enables an intermediate image to be produced (see below). Thus the navigation method generally consists of several iterations (production of several intermediate images). The first step of the navigation method is, for example, the acquisition phase that, by means of a data sensor, enables the information to be acquired necessary for the movement analysis of the mobile terminal 1. This is, for example, a pair of images just captured at a certain acquisition frequency by one or more optical sensors onboard the mobile terminal 1. The second step of the image navigation method is, for example, the phase of determining the regions of interest. The purpose of this second step is to automatically supply, for example, a set of pixel data for the regions of interest, i.e. for the zones of the initial image 8 capable of being of interest to the user, for example in semantic or contextual terms. This detection phase of regions of interest can advantageously be based on a detection method of regions of interest applied automatically at the beginning of the navigation phase, but can also attempt to use, if possible, metadata that were already extracted and formatted previously. These metadata supply all the necessary information that enable the regions of interest of the initial image 8 to be defined and used. It is important to note that in a preferred embodiment, this detection of regions of interest is performed only once at the beginning of the navigation method.

In a variant of the previous embodiment, the step of determining regions of interest can also be excluded from the closed navigation loop. Except during the first iteration where it is effectively used, the role of this step, during later iterations, is limited to supplying previously extracted information of regions of interest.

An advantageous embodiment of the invention enables the detected regions of interest to be refined. In this case, this phase of detection of regions of interest is activated at each iteration of the navigation method.

The third step of the navigation method is the estimation of the movement of directed navigation. Estimation of the movement makes use of the movement detection means 4. This movement estimation step uses the data coming from first two steps, i.e. from the steps of acquiring and determining regions of interest. These first and second steps are thus prerequisite steps, essential for running the movement estimation step. Operation of the third step depends on the second step. This explains why we speak about conditioned movement estimation. The movement detection means 4 for example recovers a pair of images just captured by one or more optical sensors with a certain acquisition frequency, and estimates, based on this spatiotemporal information, the movement applied to the terminal 1, at the time of acquisition of the image pair. The movement measurement supplies a movement amplitude and direction, as well as a characterization of the movement type, e.g. zoom, translation, rotation or change of perspective. The field of estimated movement can be local or global; it can also be obtained using dense field estimators or parametric models, and can for example enable the movement dominating other “secondary” movements (user shake and other moving objects in the scene disturbing analysis of the displacement measurement of the mobile terminal 1) to be differentiated by using robust estimators. The movement detection means 4 receives data supplied by one or more optical sensors, or one or more accelerometers, or a combination of optical sensors and accelerometers, all integrated into the terminal 1. The movements can be also calculated according to the measurement of previous movements, by using a temporal filtering method. In this case, the movement detection means 4 is comprised of two modules that can be separate or not and act successively or in parallel; the first of these modules estimating the movement applied to the mobile terminal 1 by using the data coming from the sensor, and the second module using the movement information supplied by the first module to filter it temporarily, for example with the aim of directing, if necessary, large displacement gaps between two moments. The movement detection means 4 calculates the direction of the movement transmitted to the mobile terminal 1.

The fourth and last step of the directed navigation method is the display step, which uses the movement information detected in the movement estimation step, and can also use the characteristics of the regions of interest supplied during the step of determining regions of interest. This display step takes into account all the movement and regions of interest data, as well as the characteristics of the display screen 2 and the original image 8, to best adapt or transform this original image 8 according to the region of the image displayed at the current moment and the region towards which the user wants to navigate. Unlike the movement estimation step, the use of the regions of interest data is not necessary for this step, but nevertheless recommended. The image portion best corresponding to the stimulus applied by the user is displayed full screen. The implementation of this last step activates the capture phase again, which in turn supplies the data necessary for the later steps of the image navigation method. The capture can also be activated again from the end of the movement estimation step. Several methods, or even several processors, can also work simultaneously, by taking into account the directions of the invention method, explained above. The successive display of various “intermediate” images gives the sensation of navigation or traveling along and in the initial image 8.

Mobile terminals have a specific “design” or shape factor that is planned so that they can be easily manipulated by the user, due to their portability. Known navigation methods, like the one disclosed in Patent Application WO 2004/066615, enable movement within an image or zooming, by imparting a translating movement to the mobile terminal. This technical principle is repeated in the method of the present invention. In other words, as described in document WO 2004/066615, translating or zooming movements along axes 5, 6, or 7 respectively, based on the display of an initial image 8, enable navigation in relation to said image 8, to obtain the display of another image. The other image comprises, for example, a region present in the initial image, and another region that was not present in the initial image. Preferably, axes 5, 6, and 7 define orthogonal coordinates in three dimensions. In FIG. 1, the axes 5, 6, and 7 are thus two-by-two orthogonal. In the prior art, to select one part only of the displayed initial image 8, i.e. a region of interest of the image 8, a cursor 9 that can be displayed on the screen 2 is used in combination with a key of the keyboard 3, which enables a selection window of part of the initial image 8 to be defined. This selected part of the initial image 8 is then for example zoomed, i.e. displayed enlarged on the screen. The latter manipulation is known in the prior art, but has the disadvantage of requiring the user of the mobile terminal to define, by manual selection, the zone or region of interest by means of at least one of the keys of the keyboard 3, and then to confirm, for example by a control click, the selected region of interest.

A first object of the invention is to eliminate the manual manipulations performed in the prior art by reducing to zero the number of manual operations or clicks to be performed with the keyboard 3 of the mobile terminal 1, when the user wishes to display a region of interest of an initial image 8.

A second object of the invention is to direct the navigation, and especially to improve the performance of the steps of movement estimation and use of the movement information produced with the aim of displaying a transformed image.

A third object of the invention is to reduce as far as possible the time to display full screen a region of interest selected in an initial image 8, by operating in a fast, intuitive, and user friendly way.

The invention method thus aims in particular at eliminating the disadvantages of the prior art, by eliminating manual operations to navigate in an image. Successive translating operations enable navigation based on a displayed initial image. Translating the mobile terminal, for example in the directions of axes 5 or 6, enables displacement (navigation) in relation to the initial image, in order to display another image that contains a pixel zone that did not appear on the screen during the display of the initial image; this, if the display resolution is lower than the resolution of the image to be displayed. For example, zooming is obtained by translating the mobile terminal in the direction of axis 7; axis 7 is perpendicular to the plane formed by axes 5 and 6. A disadvantage of the prior art is that the low calculation capacity of certain mobile terminals, the poor quality of the optical sensors, and the need for real-time data calculation, constrain estimators to use uncomplicated movements. These estimators of uncomplicated movements do not enable complicated fields of movement to be finely measured, such as combinations of several translating and zooming movements, the specific movements of several objects or entities placed in the observed field, movements with strong amplitudes, or again changes of perspective.

The estimation, for example of movement vectors or the parameters of a mathematical model based on an undirected search space, can turn out to be not very robust. This lack of robustness can mean, on the one hand, erroneous movement measurements causing unexpected and incorrect translating or zooming during the navigation step, and on the other hand, some difficulty in converging easily and quickly onto a region of interest. Thus there is no perfect match between the movements applied to the mobile terminal 1 by the user, and the transformation applied to the image during the navigation. The method according to the invention aims at eliminating these disadvantages, which lead to laborious and/or inaccurate navigation.

According to FIG. 2, the invention aims to use the result of a detection or a prior selection of region(s) of interest, e.g. regions of interest 10 and 11 of the initial image 8, to direct, and thus improve, the estimation phase of movement between two moments (movement measurement and any temporal filtering of these measurements), as well as the display phase (adaptation and/or transformation of the initial image 8 for display purposes). This movement information can be, for example, movement vectors or the parameters of a mathematical model. The addition of a direction based on knowledge of the regions of interest 10 and 11 of the initial image 8 enables correct display of the intermediate images, produced between the initial image and the image of the region of interest for example.

In a preferred embodiment of the invention, the determining of one or more regions of interest starts off the navigation method, i.e. determining the regions of interest is performed even before or at the same time as the first acquisition of data by the capture system. To determine the regions of interest 10 and 11, we use, for example, a detection method of light colors present in an image, or more advantageously a detection method of faces, for example, based on a preliminary statistical learning of the key features of a face based on an image base representative of the variety of faces and lighting and capture conditions. Detection of regions of interest can also be based on the color or structural properties of the image (texture, spatial intensity gradients) or again on contextual criteria (date and place information, association and exploitation of indexed data). This type of face detection method is known in the prior art. Regions of interest can be determined in batch (or background) mode directly on the mobile terminal 1, but independently of the navigation method, or in real time, i.e. just before the navigation step. In this first embodiment, the method according to the invention, based on the display of an initial image 8, automatically determines at least one region of interest 10 and 11 of the initial image 8.

Another preferred embodiment of the detector of regions of interest enables the direct and easy recovery of previously calculated characterization metadata of the regions of interest 10 and 1, these being advantageously memorized, for example, in the header of a EXIF file (Exchangeable Image File) of the JPEG method or by means of any other type of format that can be interpreted by the determination method of regions of interest. This embodiment has the advantage of shifting the determination of regions of interest towards remote calculation units having greater calculation capacity. The determination of regions of interest can thus benefit from more powerful algorithmic tools because of the greater calculation possibilities, and also be more robust and accurate. The response or activation time of the image navigation method is also greatly improved because the metadata extraction step is clearly much faster than the actual detection of the regions of interest. The features of JPEG 2000 can be used to decompress only the regions of interest. In FIG. 2, the determined region of interest 10 and 11, has a square or rectangular shape; but the pixel zone of the determined region of interest can also be bounded by a circular or elliptic line, or any shape enabling the inclusion of the searched subject 14 and 15 placed in said zone.

In another embodiment, the determination of the regions of interest can be directed to one zone of the image, determined by the initial direction, obtained by the movement detection means 4, at the beginning of the navigation step. More precisely, a first iteration of the navigation method can be carried out, which enables the direction to be known towards which the user wants to navigate in the image. Thereafter, i.e. during the next iterations, the step of determining regions of interest can be tried again, to refine or improve each of the regions of interest initially detected during the first iteration. This improvement is made possible by the knowledge of the navigation direction, which enables more efficient focusing and work on a precise region of the image. It is also possible, in a different embodiment, to begin the determining method of the regions of interest only during the second iteration. The first iteration again acting to define the image navigation direction and thus to determine the zone of the initial image 8 within which a region of interest is looked for.

A combination of the various modes of determining regions of interest presented above is also possible.

The movement estimation step that follows the phase of determining regions of interest can also be performed at the same time as this one. It enables, for example, navigation from a state where the initial image 8 is displayed full screen towards a state where the image of a region of interest is also displayed full screen, and in an intuitive, fast and simple way. The joint use of properties specifying the regions of interest of the original image 8 enables improved reliability and a faster calculation of the movement information. Navigation can be performed, for example, by means of a simple movement imparted to the mobile terminal 1, e.g. a brief translating movement towards the region of interest 10 in the direction V1, in the plane formed by axes 5 and 6. According to another embodiment, the movement transmitted to the mobile terminal 1 can also be a brief translating movement towards the region of interest 11, in the direction V2, combined with a brief zooming movement forwards in an axis perpendicular to the plane formed by axes 5 and 6. The movement imparted to the mobile terminal 1 can also be preferably a brief movement of tilting the mobile terminal 1 in the direction of the region of interest. The movement is called “brief”, in the sense that its amplitude must be low enough to be capable of being determined by the movement estimator. In other words, the content present in two successive images used during the movement measurement is sufficiently correlated, to enable correct movement estimation, in amplitude and direction. V1 and V2 are vectors characterizing the displacement to reach the region of interest. V1 and V2 are calculated, based on information of movement direction, movement amplitude, and type of movement. The type of movement is, for example, zooming, translating, rotating, or changing perspective. The calculated displacement vector V1 and V2 constitutes information enabling automatic and quick navigation towards the corresponding region of interest 10 and 11. The method according to the invention, because of the prior knowledge of the region of interest (determined automatically), makes the estimation of the displacement vectors V1 and V2 more robust.

The knowledge of one or more regions towards which the navigation is going to be made enables direct action on the movement estimation performance. Advantageously, in a particular embodiment, for example, it is possible to reduce the search space representing the variety of movement amplitudes and directions. It may be supposed, for example, that a single region of interest 10 was determined, and that it is situated at the top left of the initial image 8. In this case, it is particularly interesting to limit or again favor the search for possible movements applied by the user to those authorizing navigation from the centre of the initial image 8, towards the centre of the region of interest 10. The space or all the directions that the movement detection means 4 will have to cover to determine the optimal direction in relation to the data and directions is thus reduced, which enables the search time to be reduced (and thus the calculation time) or again the accuracy of the search to be increased in certain directions (finer sampling).

In another embodiment of the estimation of the directed movement, the region-of-interest direction (location in the initial image) does not act on the size or sampling of the search space, but tends to apply weightings penalizing or favoring certain movements to the benefit of others. For example, by taking the previous example where the region of interest 10 is situated at the top left of the image 8, it is possible to cover the whole search space, i.e. to also take account, for example, of potential movements going downwards and to the right, but by applying different weightings to them. A potential movement going downwards to the right will be assigned a low weighting (or a low probability), while a possible movement upward to the left will be assigned a higher weighting, which translates the fact that the knowledge held on the location of the regions of interest of the image 8 leads to favoring directions enabling navigation towards said zones. Whichever embodiment is used, it nevertheless seems more flexible not to totally forbid certain movements so as not to restrict the user too much in case of unpredictable behavior. In this case, a movement estimate including weighting according to the directions of the regions of interest is more suitable. A later phase of temporal filtering of the movement measurements made can also enable adaptation to unpredictable behavior.

In a preferred embodiment, the method according to the invention includes a temporal filtering phase, applied to the movement information calculated by the first module of the movement detector 4. Temporal filtering consists in using a limited set of prior movement information. This prior movement information, calculated previously (during the previous iterations) during the navigation across the image 8, is used as an aid to determining or validating current movements. This set of prior movement information is commonly called history, while the current movement measurement is generally called innovation. Temporal filtering can be implemented directly at the time of measuring the movement applied to the mobile terminal 1. Temporal filtering can be also used later, to smooth or simply validate/invalidate the last movement measurement, according to the prior movement measurements. If temporal filtering is used directly during the measurement, the movement directions and amplitudes correlated with those calculated previously will be preferred during movement estimation. If temporal filtering is carried out later, i.e. after the movement measurement, the history can be used to validate the current measurement, if it is consistent with the prior movement information, or to invalidate it should the opposite occur (inconsistency). A preferred method consists in smoothing or interpolating the last measurement, according to the history, to minimize possible error, due to a locally inaccurate movement measurement. In a preferred embodiment, temporal filtering advantageously benefits from the information of regions of interest. The regions-of-interest direction can be applied during the movement estimation, during temporal filtering, or at each of these two steps. Knowing the zones to which the navigation will probably go enables particularly acceptable smoothing of the movement measurements. For example, the effect of smoothing the last movement measurement according to the history and regions-of-interest directions enables a cleaner, more regular navigation path to be created.

An advantage of the invention compared with the prior art enables, in particular, not only automatic navigation, but also more fluid and more regular navigation towards the wanted region of interest. Navigation based on the initial image 8, is performed automatically, by shifting or modifying the region of image to be displayed, and for every iteration of the navigation method, according, on the one hand, to the direction information calculated by the movement detection means 4, and on the other hand, to the extracted regions of interest and characteristics of the display screen 2. This display step selects the image zone to be displayed, for example, by shifting the previously displayed image portion, by a translating factor (top left) corresponding to the displacement vector calculated in the current iteration and by zooming in the initial image 8, and this always being suited to the movement measurement. The intermediate images obtained in each iteration represent, during the navigation step of the method according to the invention, the path to be taken to reach the region of interest 10 and 11, departing from the initial image 8.

The last image coming from the automatic navigation towards the region of interest represents the region of interest, displayed full screen. In a preferred embodiment of the invention, the user is notified that the region of interest is reached, by the activation, for example, of a vibrator or buzzer built into the mobile terminal 1. In an advantageous embodiment of the invention, the user is notified that the region of interest is reached, by an increased damping of the displacement imparted by the automatic navigation. The transformed image 12 and 13 represents the region of interest 10 and 11. The region of interest 10 and 11 represents, for example, an image 12 and 13 of faces 14 and 15 of people who were part of the initial image 8.

Based on the display of the initial image 8 whose file can include metadata specific to the regions of interest of this image 8, if the user of the mobile terminal 1 advantageously wishes to display full screen 2, the face 15 of the image 8, they tilt for example the mobile terminal towards the face 15. In other words, they tilt the mobile terminal in the direction represented by the vector V1. In this case, tilting the terminal to display the face 15, means, for example, imparting a combined zooming and translating movement, the translating axis being within the plane formed by axes 5 and 6, and the zooming movement being made according to axis 7. In another embodiment, to display the face 15, a simple translating movement of the terminal in the direction V1 in the plane formed by axes 5 and 6, is performed. The movement transmitted to the mobile terminal 1 is a movement made in the three dimensional space defined by axes 5, 6, and 7.

In an embodiment compatible with common usage, the navigation method does not necessarily end when one of the regions of interest has been reached. Indeed, the user may wish to return to a state where the initial image 8 is displayed full screen again, or go towards another region of interest, found during the phase of detecting regions of interest. In this embodiment, the navigation only stops when the user decides.

In another embodiment, the invention can be implemented with a second terminal (not shown). The second terminal comprises a display screen and can connect to the mobile terminal 1, with a wire ink, or advantageously a wireless link. For example, the wireless link is a Bluetooth type link. The movement detection means is placed in the mobile terminal 1, and not in the second terminal.

The method according to the invention is compatible with an initial image 8 comprising many of regions of interest 10 and 11. Thus it is possible to converge on various regions of interest, according to the measurements produced by movement detection means. The regions of interest are determined to keep sufficient level of detail of the image of the region of interest to be displayed full screen, and compatible with the display capacity of the mobile terminal.

The invention has been described in detail with reference to its advantageous embodiments. But, it is clear that the described embodiments should not prevent variants equivalent to the described embodiments from coming within the scope of the claims.

1) A method of navigating automatically towards a region of interest of an initial image, using a device comprising a mobile terminal, a spatiotemporal movement detection means, and a display means; and comprising the following steps:
a) displaying the initial image on the display means;
b) automatically determining at least one pixel zone of the initial image, the pixel zone representing a region of interest of the initial image;
c) automatically measuring, using the movement detection means, spatiotemporal changes imparted by a displacement of the mobile terminal;
d) automatically linking the data of pixels specific to the regions of interest detected in step b) and the spatiotemporal changes measured in step c) to automatically estimate movement information;
e) automatically navigating, based on the movement information and using the data of pixels specific to the regions of interest of the initial image, towards the defined region of interest with a sequential display of intermediate images;
f) automatically displaying the image of the region of interest, full screen on the display means.

2) The method according to claim 1, wherein the automatic determination of the region of interest of the initial image is performed before the display of said initial image on the display means.

3) The method according to claim 1, wherein the initial image has many regions of interest that can be displayed successively on the display means.

4) The method according to the claim 1, wherein the movement of the mobile terminal at the origin of the navigation is a tilt.

5) The method according to the claim 1, wherein the movement of the mobile terminal at the origin of the navigation is translating in the plane of the image or translating perpendicularly to said plane.

6) The method according to the claim 1, wherein the movement of the mobile terminal is a combination of translating in the plane of the image and a tilt in relation to said plane.

7) The method according to claim 1, wherein the display means is a display screen of the mobile terminal.

8) The method according to claim 1, wherein the display means comprises a second terminal provided with a display screen and capable of connecting to the mobile terminal.

9) The method according to claim 1, wherein the mobile terminal is a cellphone that comprises a display screen and a movement detection means.

10) The method according to claim 1, wherein the mobile terminal is a camera that comprises a display screen and a movement detection means.

11) The method according to claim 1, wherein the display means is a portable digital reader that comprises a display screen and a movement detection means.

12) The method according to claim 9, wherein the movement detection means comprises at least one optical sensor.

13) The method according to claim 9, wherein the movement detection means comprises at least one accelerometer.

14) The method according to claim 2, wherein the initial image has many regions of interest that can be displayed successively on the display means.

15) The method according to claim 2, wherein the display means comprises a second terminal provided with a display screen and capable of connecting to the mobile terminal.

16) The method according to claim 10 wherein the movement detection means comprises at least one optical sensor.

17) The method according to claim 11 wherein the movement detection means comprises at least one optical sensor.

18) The method according to claim 10, wherein the movement detection means comprises at least one accelerometer.

19) The method according to claim 11, wherein the movement detection means comprises at least one accelerometer.
